(19) United States
(12) Patent Application Publication
(10) Pub. No.: US 2013/0175085 A1
(43) Pub. Date: Jul. 11, 2013

(54) Connector

(71) Applicant: Keita Terajima, Tokyo (JP)

(72) Inventor: Keita Terajima, Tokyo (JP)

(21) Appl. No.: 13/650,748

(22) Filed: Oct. 12, 2012

(30) Foreign Application Priority Data
Oct. 13, 2011 (JP) 2011-225953

(51) Int. Cl. H02G 3/18

(52) U.S. Cl. 174/650

(57) ABSTRACT

A connector includes an insulation board, a conductor pattern, a rod-shaped member and a solder. The insulation board is provided with a through hole penetrating from a top face to a bottom face. The conductor pattern covers an internal wall of the through hole. The rod-shaped member includes a first end protruding beyond the bottom face and a second end inside the through hole. The solder closes a gap between the conductor pattern covering the internal wall of the through hole and the rod-shaped member and covers the second end of the rod-shaped member.

### CROSS-REFERENCE TO RELATED APPLICATION

This application claims the benefit of the filing date under 35 U.S.C. §119(a)-(d) of JP Patent Application No. 2011-225953 of Oct. 13, 2011.

### FIELD OF THE INVENTION

The present invention relates to a gas tight electrical connector.

### BACKGROUND

One such known connector carries out an electrical connection between an inside and an outside of a partition wall of a vacuum chamber whose inside is decompressed. This connector has a board which is attached at a position to close an opening of the partition wall, and the board has a through hole which extends from a top surface to a bottom surface thereof and whose inside is filled with solder.

As a configuration including a through hole filled with solder therein, for example, Japanese Patent Publication JP 2009-99779A illustrates a printed circuit board having a through hole. A lead of a mounted component goes through the through hole and the through hole is filled with solder. In the printed circuit board, in order to accelerate cooling speed upon soldering, an area of the through hole land continuing to the through hole is made large to increase the heat radiation efficiency. This attempts to reduce cracking (shrinkage cavity) produced on a solder surface as the cooling speed decreases.

In the above-described printed circuit board, the lead penetrates the solder on both the top surface and the bottom surface, and an interface between the lead and the solder is exposed on both the top surface and the bottom surface. Thus, when atmospheric pressure difference is applied to the top surface and the bottom surface, a gas may leak along the interface between the lead and the solder.

The configuration just described is an indication that such units can be arranged with only solder in the through hole. However, in this case, if a reflow soldering process using a solder paste is applied in volume(mass) production, a volatile component of the solder paste filling in the through hole is lost and the volume remarkably reduces. As a result, the solder is made thin inside the through hole and may be broken by a filling failure or a difference in atmospheric pressure.

### SUMMARY

The present invention has been made in view of the above circumstances and provides a connector having improved gastightness.

According to an aspect of the present invention, a connector includes an insulation board, a conductor pattern, a rod-shaped member and solder. The insulation board has a top surface, a bottom surface, and a through hole extending from the top surface to the bottom surface. The conductor pattern covers an internal wall of the through hole. The rod-shaped member extends in the through hole in a direction intersecting the top surface and has a first end protruding from the bottom surface and a second end opposite to the first end within the through hole. The solder closes a gap between the conductor pattern covering the internal wall of the through hole and the rod-shaped member and covers the second end of the rod-shaped member.

### BRIEF DESCRIPTION OF THE DRAWINGS

FIG. 1 is a perspective view illustrating a top face of a connector according to a first embodiment of the present invention;

FIG. 2 is a perspective view illustrating a bottom face of the connector according to the first embodiment of the present invention;

FIG. 3 is a sectional view illustrating a cross section of the connector illustrated in FIG. 1 taken along line 3-3 of FIG. 1;

FIG. 4 is a perspective view illustrating a first step for producing the connector illustrated in FIGS. 1-3;

FIG. 5 is a sectional view illustrating a second step for producing the connector illustrated in FIGS. 1-3;

FIG. 6 is a sectional view illustrating a third step for producing the connector illustrated in FIGS. 1-3;

FIG. 7 is a sectional view illustrating a comparative example in which a rod-shaped member is omitted;

FIG. 8 is an illustration an example of an application of the connector 1 illustrated in FIGS. 1-3; and

FIG. 9 is a perspective view illustrating a portion of a connector according to a second embodiment.

### DETAILED DESCRIPTION OF THE EMBODIMENTS

Exemplary embodiments according to the present invention will be described with reference to the drawings.

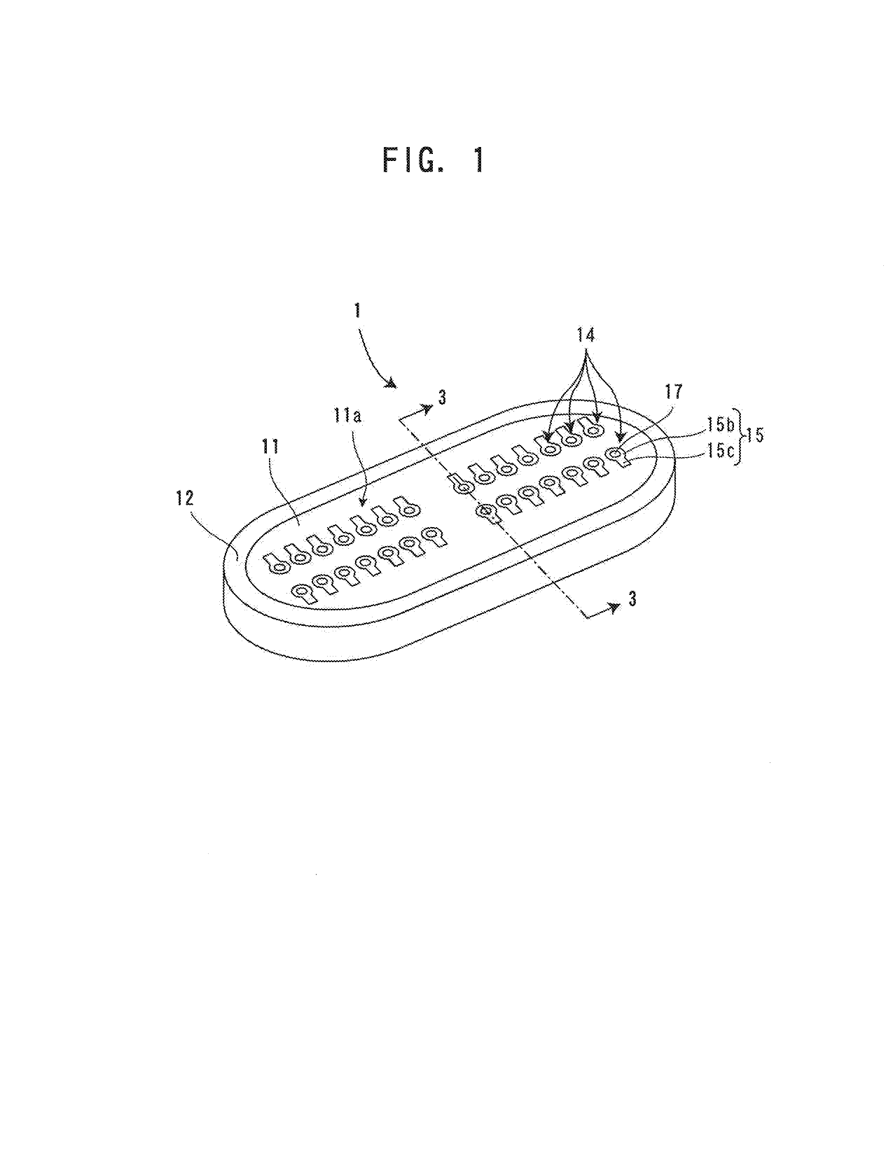

The connector 1 illustrated in FIGS. 1-3 is a tabular component. The connector 1 is attached to a position where the connector 1 covers an opening of a partition wall which will be described later and serves for an electrical connection between an inside and an outside of the partition wall via the opening. The connector 1 is attached with a top face 11a thereof illustrated in FIG. 1 facing the partition wall. The connector 1 includes an insulation board 11 and electrical connection sections 14.

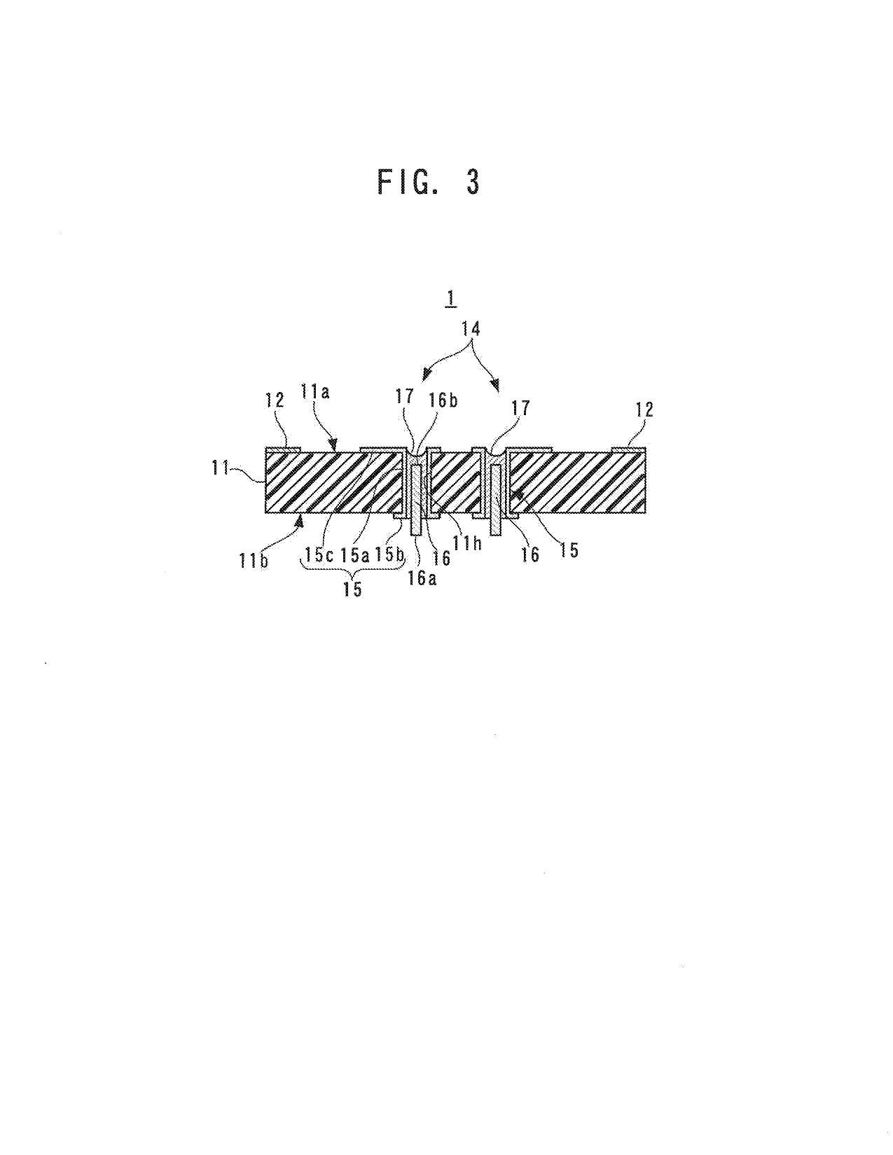

The insulation board 11 is a tabular component made of an insulating material. The material of the insulation board 11 is, for example, glass-containing epoxy or ceramic. The insulation board 11 includes the top face 11a facing the partition wall and a bottom face 11b which is a face opposite to the top face. The insulation board 11 includes through holes 11h (see FIG. 3) extending from the top face 11a to the bottom face 11b of the insulation board 11. In addition, a strip-shaped sealing metal plating pattern 12 is provided along a periphery of the top face 11a of the insulation board 11. The strip-shaped sealing metal plating pattern 12 is formed by plating with metal.

The connector 1 illustrated in FIG. 1 is a connector having 28 positions of electrodes and 28 positions of electrical connection sections 14 are arranged in the insulation board 11 of the connector 1. The strip-shaped sealing metal plating pattern 12 surrounds the 28 positions of electrical connection sections 14 which are exposed on the top face 11a.

As illustrated in FIG. 3, each of the electrical connection sections 14 includes, a connecting conductor pattern 15, a rod-shaped member 16 and solder 17.

Each of the connecting conductor pattern 15 is formed by plating with metal and includes an inner wall section 15a, edge sections 15b, and contact sections 15c. Each of the inner wall sections 15a covers an internal wall of each of the through holes 11h. The edge sections 15b continue to the inner wall section 15a and spread in an annular ring shape at opening edge portions of the through hole 11h. The contact sections 15c project from rims of the edge sections 15b on both of the top face 11a and the bottom face 11b of the insulation board 11.

Each of the rod-shaped members 16 has a bar shape of a cylindrical column and is formed of metal having a melting temperature higher than that of the solder 17. The rod-shaped members 16 extend axially of the through holes 11h in a direction intersecting the top face 11a of the insulation board 11. Specifically, each of the through holes 11h extends in an angle approximately perpendicular to the top face 11a of the insulation board 11, and the rod-shaped members 16 extend approximately along or in parallel with the axes of through holes 11h, that is, approximately perpendicularly to the top face 11a. A first end 16a of each of the rod-shaped members 16 protrudes beyond the bottom face 11b. In addition, a second end 16b, opposite to the first end 16a, is inside each of the through holes 11h. In other words, a portion of each of the rod-shaped members 16 is inside each of the through holes 11h and a remaining portion lies outside of each of the through holes 11h. More specifically, the rod-shaped members 16 are within the respective through holes 11h by more than a half of thickness of the insulation board 11 (that is, a length of the through hole 11h).

The diameters of the rod-shaped members 16 are smaller than the internal diameters of the through holes 11h provided with the connecting conductor patterns 15. The rod-shaped members 16 are spaced apart from the internal walls of the through holes 11h and do not make contact with the internal walls. More specifically, the rod-shaped members 16 are arranged at the approximate centers of the through holes 11h (i.e., the axes of the through holes).

The solder 17 is a metal alloy predominantly composed of tin. The solder 17 is formed through a process in which a solder paste is heated in a reflow soldering process. The solder 17 closes a gap between the internal wall of each of the through holes 11h and each of the rod-shaped members 16, more specifically, a gap between each of the connecting conductor patterns 15 provided on the internal wall of the through holes 11h and each of the rod-shaped members 16. As described above, since the rod-shaped members 16 do not make contact with the internal walls of the through holes 11h, the solder 17 surrounds the entire periphery of each of the rod-shaped members 16. In other words, the solder 17 exists all around each of the rod-shaped members 16 between each of the rod-shaped members 16 and each of the conductor patterns 15 in through holes 11h. In addition, the solder 17 covers the second ends 16b of the rod-shaped members 16 inside the through holes 11h. In other words, that portion of a through hole 11h not having a rod-shaped member 16 is filled only with the solder 17.

The solder 17 is fused with the connecting conductor patterns 15 covering the internal walls of the through holes 11h and also is fused with the rod-shaped members 16. Thus, each of the electrical connection sections 14 has a structure in which each of the through holes 11h is closed in a gastight manner by each of the connecting conductor patterns 15, each of the rod-shaped members 16 and the solder 17.

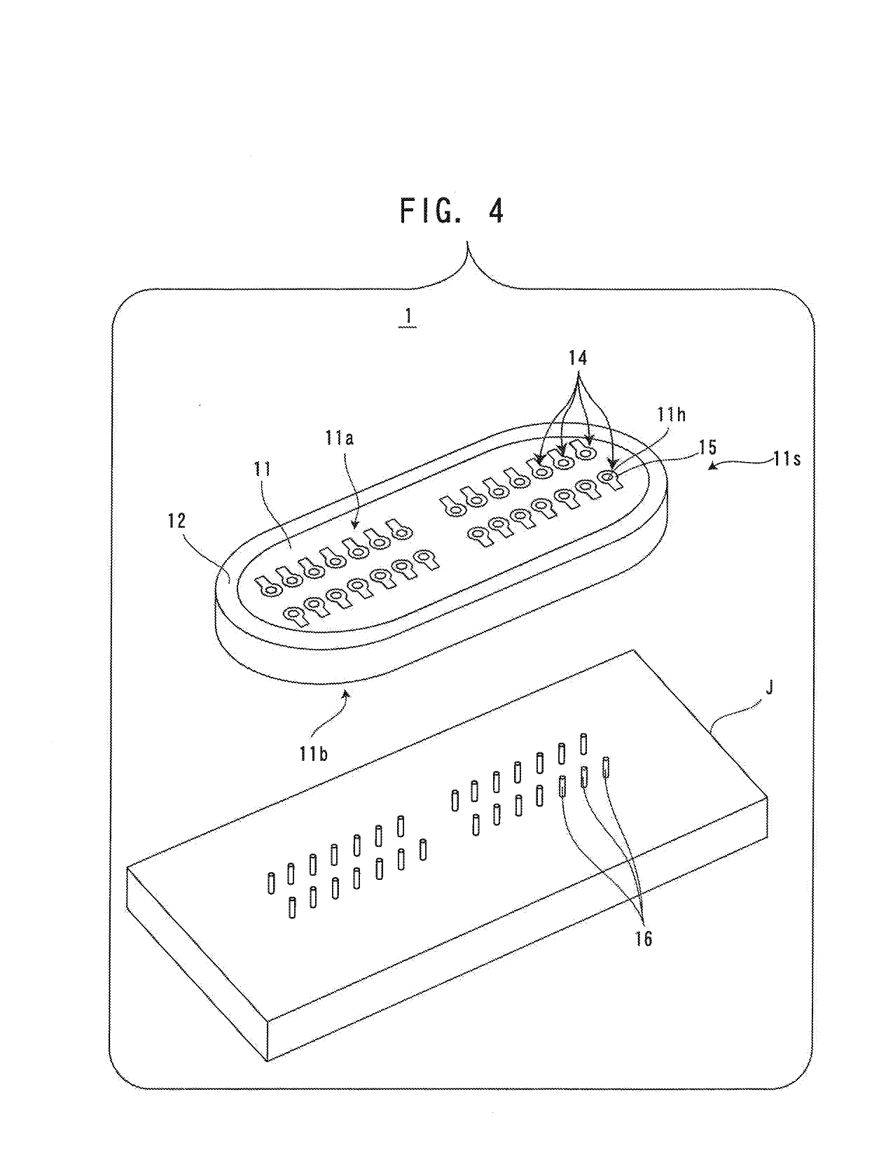

FIGS. 4-6 are views illustrating steps for producing the connector 1 illustrated in FIGS. 1-3. FIG. 4 is a perspective view illustrating a first step for producing the connector 1.

In the first step, firstly, the through holes 11h are formed in the insulation board 11 and the strip-shaped sealing metal plating pattern 12 and the connection conductor patterns 15 are formed by plating with metal. Next, a tabular jig J is prepared and the rod-shaped members 16 are arranged on the jig J. The jig J is not deformed and transformed at a solder molten temperature and is formed of a material resistant to being adhered with molten solder (the degree of wetting (wettability) is low). The material of the jig J, for example, may be carbon. The jig J is provided with openings having an arrangement similar to that of the through holes 11h in the connector 1, into each of which openings a portion of each of the rod-shaped members 16 is inserted.

Next, the insulation board 11, on which the strip-shaped sealing metal plating pattern 12 and the connecting conductor patterns 15 are formed, is placed on the jig J on which the rod-shaped members 16 are arranged. At this moment, the bottom face 11b of the insulation board 11 faces the jig J.

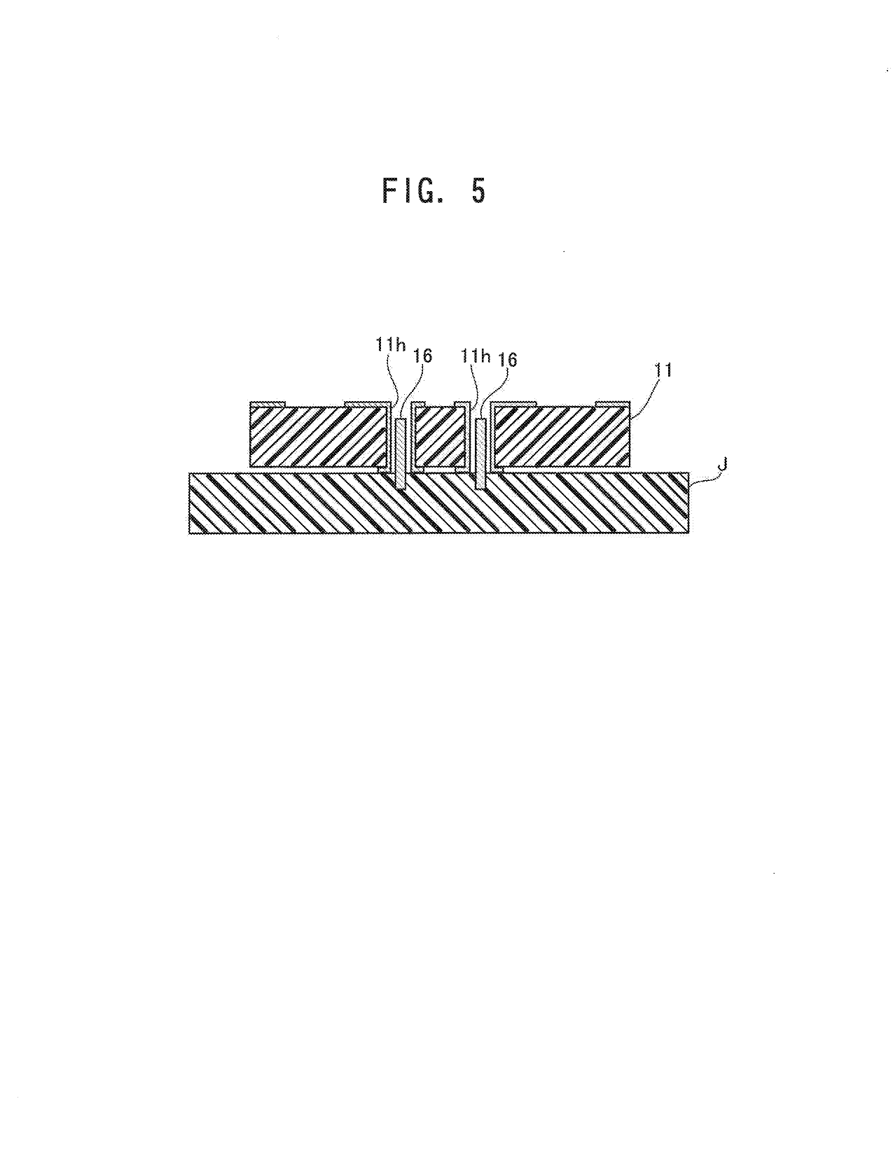

FIG. 5 is a sectional view illustrating a second step for producing the connector 1.

In the second step, the insulation board 11 is placed on the jig J such that the rod-shaped members 16 are inserted into the through holes 11h of the insulation board 11. The insulation board 11 is positioned relative to the jig J such that the rod-shaped members 16 are positioned at centers of the through holes 11h.

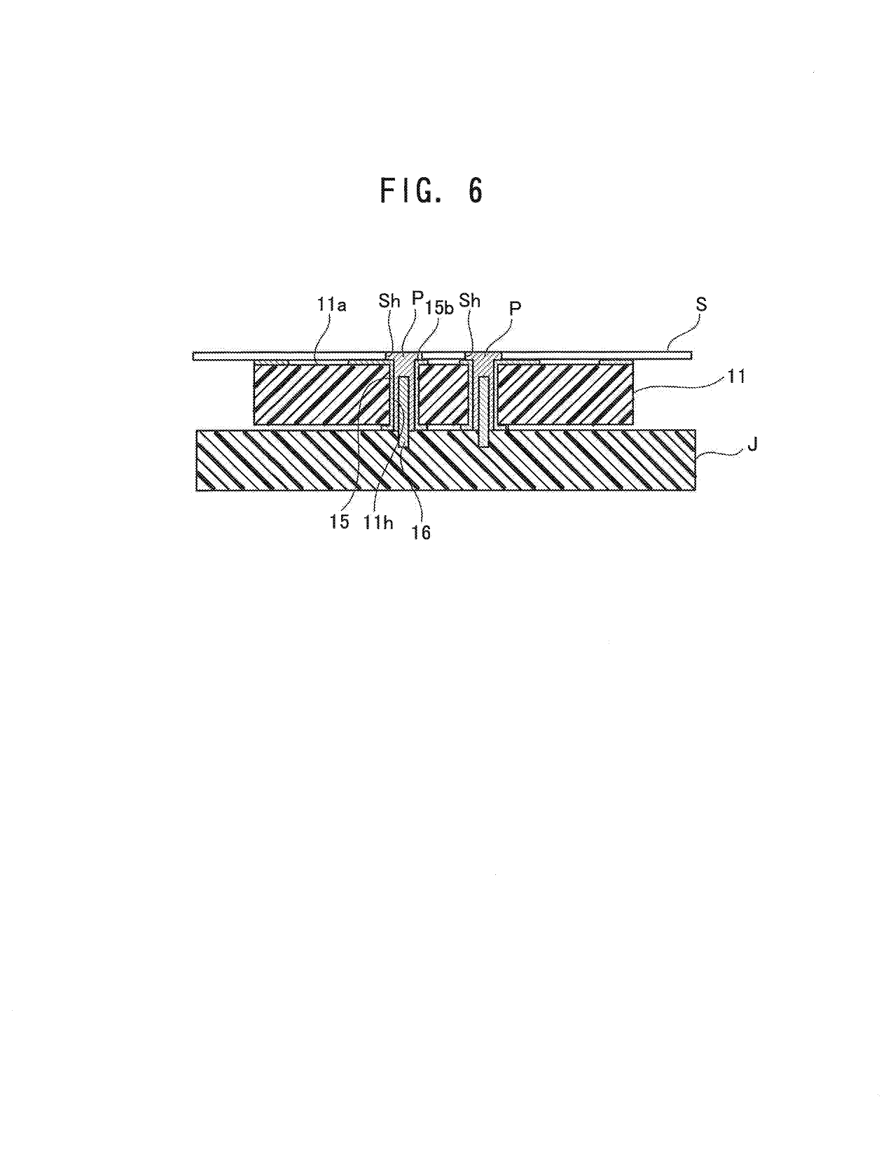

FIG. 6 is a sectional view illustrating a third step for producing the connector 1.

In the third step, the through holes 11h of the insulation board 11 are filled with solder paste P to be the solder. Specifically, firstly, a pattern (stencil) S with openings Sh having an arrangement similar to that of the through holes 11h is placed on the top face 11a of the insulation board 11. The openings Sh of the stencil S are larger than the diameter of the through holes 11h and each of the openings Sh has a size of the extent of the edge sections 15b of the connecting conductor patterns 15 (see FIG. 1). Next, by using a squeegee made of, for example, rubber, the solder paste P is squeezed into the through holes 11h from the openings Sh of the stencil S. Through this step, the through holes 11h are filled with the solder paste P. Solder paste P fills the space between the rod-shaped members 16 and the conductor patterns 15 inside the through holes 11h surrounding entire periphery of the rod-shaped members 16. In addition, the solder paste P covers the second ends 16b of the rod-shaped members 16 to close the through holes 11h.

Next, the stencil S is removed and the reflow soldering process is applied to heat the solder paste while the insulation board 11 remains placed on the jig J. The reflow soldering process has higher manufacturability, compared with a solder flow process in which a board is dipped in molten solder. The solder paste P is heated and so metal components are molten and fuse with the connecting conductor patterns 15 covering the internal walls of the through holes 11h. As a result, the connector 1 illustrated in FIG. 3 is completed.

A solder paste used in the reflow soldering contains volatile components which are evaporated and lost at the temperature of the reflow soldering process. For example, more than a half of the volume of the solder paste is made up of the volatile components. For this reason, the volume of the solder 17 (see FIG. 3) is reduced to be less than a half, compared with the solder paste P (see FIG. 6), and as illustrated in FIG. 3, distances (heights) by which the solder 17 fills the through holes 11h are smaller than the whole lengths of the through holes 11h.

However, in the connector 1 according to the present embodiment, the rod-shaped members 16 which do not include volatile components are arranged inside the through holes 11h. The rod-shaped members 16 do not have their volume reduced even by being heated. The amount of the solder paste P (see FIG. 6) in each of the through holes 11h may be reduced by a portion of the volume occupied by each of the rod-shaped members 16 in each of the through holes 11h. For this reason, the amount of the volume, reduced when the solder paste P becomes the solder 17 through the reflow soldering process, is reduced.

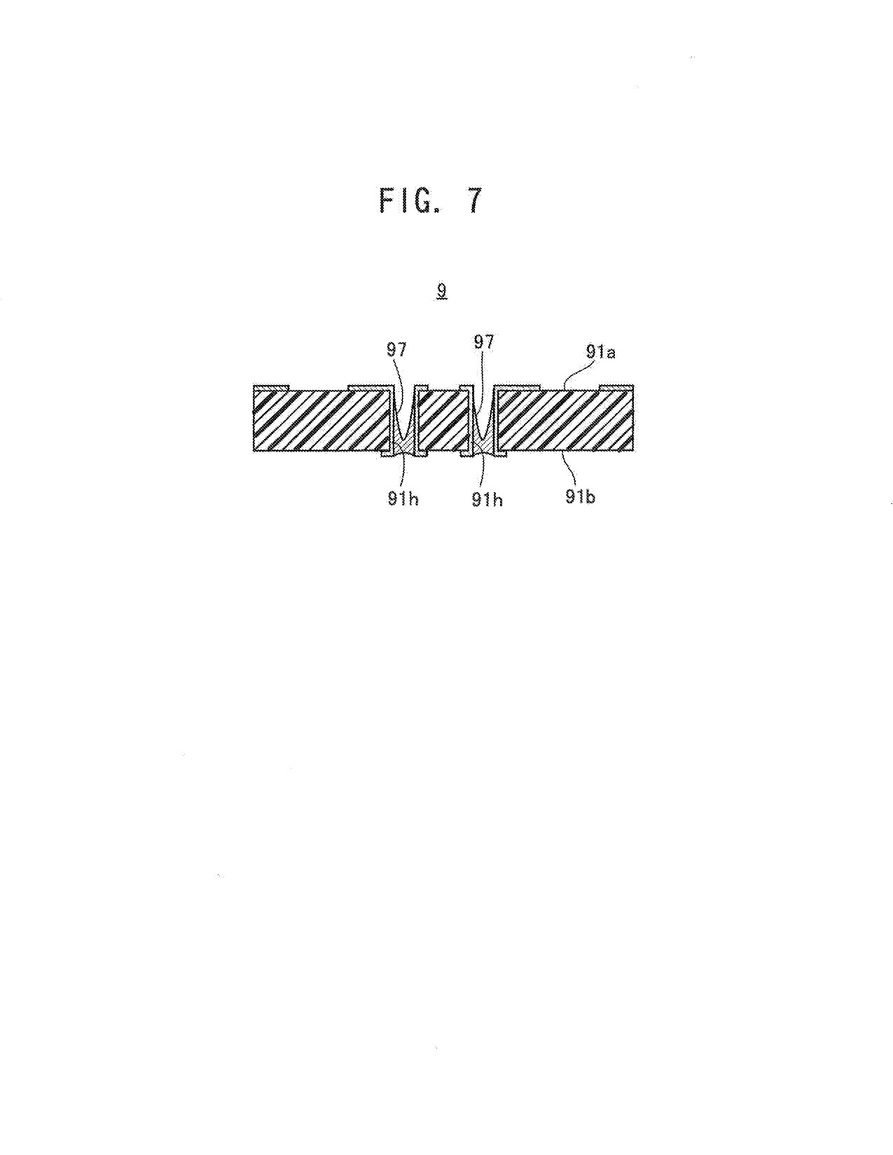

FIG. 7 is a sectional view illustrating a comparative example in which a rod-shaped member is not arranged in a through hole.

In a connector 9 of the comparative example illustrated in FIG. 7, there is no rod-shaped member, but only solder 97 in through holes 91h. For this reason, in the connector 9, the amount of volume reduced when the solder paste becomes the solder 97 through a reflow soldering process is large. Thus, the extent over which the solder fills the through holes 91h becomes small. In the connector 9 of the comparative example, when a pressure difference is applied to a top face 91a and a bottom face 91b of the connector 9, the solder 97 may be damaged, and thus there is a possibility of gastightness being decreased.

In the connector 1 according to the present embodiment illustrated in FIG. 3, the amount of reduced volume when the solder paste P becomes the solder 17 through a reflow soldering process is reduced, compared with the comparative example illustrated in FIG. 7. In the connector 1, since the extent over which each of the through holes 11h is filled is large, damage of the solder 17 is prevented under an environment where there is a pressure difference. Accordingly, the gastightness of the electrical connection section 14 is high. In addition, the solder 17, being around the rod-shaped members 16, fills the respective narrow gaps between the conductor patterns 15 lining the internal walls of the through holes 11h which can be assumed to be rigid and the rod-shaped members 16 which can be assumed to rigid. Also for this reason, the gastightness is enhanced.

Further, in the connector 1 according to the present embodiment, the second ends 16b of the rod-shaped members 16 are inside the through holes 11h and covered by the solder 17. In other words, the interface between each of the rod-shaped members 16 and each of the solder 17 is not exposed outside on the side of the top face 11a of the insulation board. For this reason, for example, compared with a case in which a rod-shaped member extends through a through hole, a leak of a small quantity of gas through the interface between each of the rod-shaped members 16 and each of the solder 17 is reduced. In addition, a leak of gas by a crack and the like produced between each of the rod-shaped members 16 and the solder 17 due to an external force applied to the rod-shaped member 16 and a difference of thermal coefficients of the expansion is decreased. Thus, the gastightness of the connector 1 according to the present embodiment is further improved. In the connector 1, according to the present embodiment, since the rod-shaped members 16 are made of metal, they are easily adhered with solder in a reflow soldering process. For this reason, solder escaping from one of the second ends 16b of the rod-shaped members 16 or from the interfaces between the rod-shaped members 16 and the solder 17, both on the side of the top face 11a of the insulation board 11, is prevented.

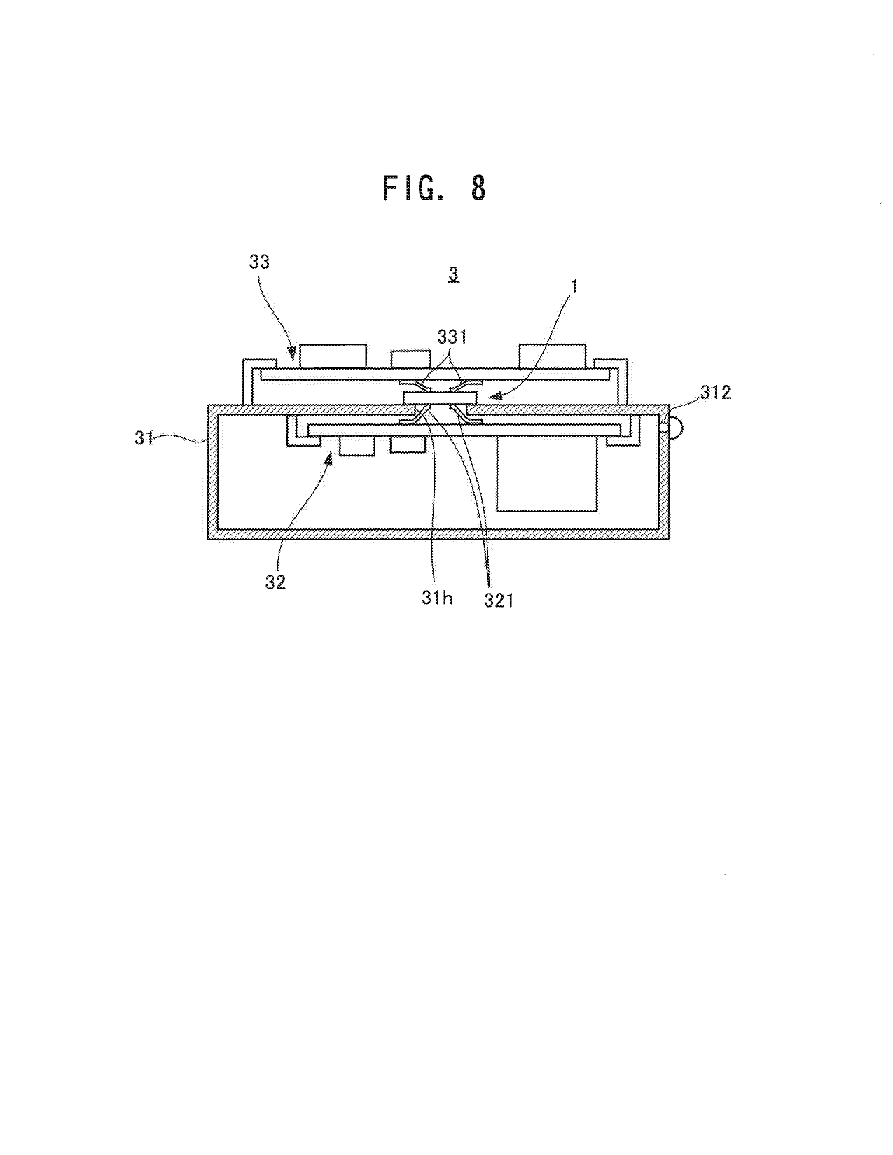

FIG. 8 illustrates an example of an application of the connector 1 illustrated in FIGS. 1-3. An apparatus 3 illustrated in FIG. 8 is a chamber apparatus which operates in an environment in which a pressure and composition are adjusted. Specifically, the apparatus 3 includes a partition wall 31, an internal circuit board 32, an external circuit board 33 and the connector 1 illustrated in FIGS. 1-3. In FIG. 8, the connector 1 is arranged with the top face 11a illustrated in FIG. 1 facing downward.

The partition wall 31 is a container which partitions off an inner space from an outer space. The internal circuit board 32 is arranged inside the partition wall 31. An electronic component and a constitutional device which operate in an environment of being decompressed or compressed are contained inside the partition wall 31. The partition wall 31 includes a wiring opening 31h for electrical wiring. The connector 1 is larger than the wiring opening 31h, and is attached at a position covering the wiring opening 31h to close the wiring opening 31h. Specifically, the insulation board 11 (see FIG. 1) of the connector 1 closes the wiring opening 31h. In addition, the connector 1 serves for an electrical connection through the wiring opening 31h between an inside and an outside of the partition wall 31. Solder as a sealing member seals between the strip-shaped sealing metal plating pattern 12 provided on the insulation board 11 of the connector 1 (see FIG. 1) and the partition wall 31.

The external circuit board 33 is arranged outside the partition wall 31, supplies electrical power to the internal circuit board 32, and also controls the internal circuit board 32.

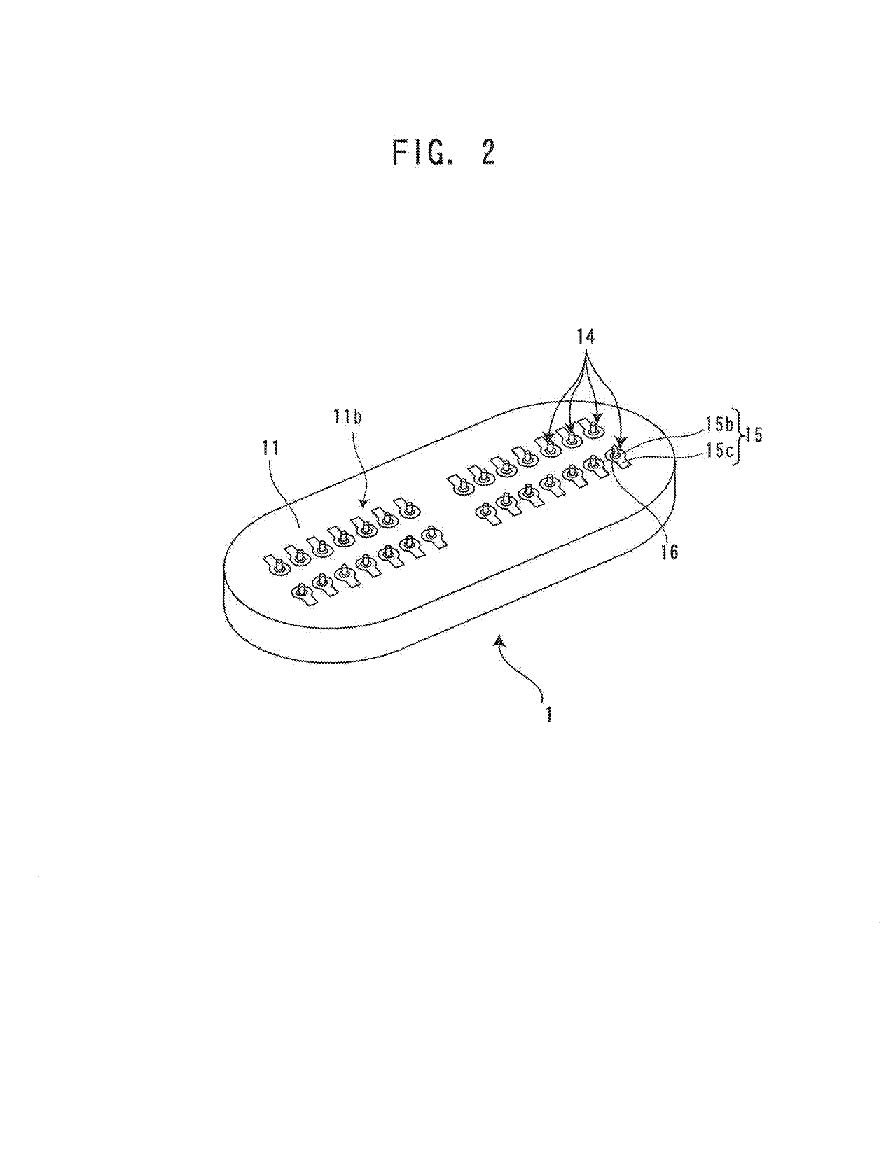

The connector 1 serves to connect the internal circuit board 32 and the external circuit board 33. The internal circuit board 32 and the external circuit board 33 include contacts 321 and 331 to make contact with the connector 1, respectively. The contacts 321 and 331 make contact with the connection sections 15c of the connecting conductor patterns 15 (see FIGS. 1 and 2) included in the connector 1. The internal circuit board 32 and the external circuit board 33 are electrically connected with each other via the electrical connection sections 14 (see FIG. 3) of the connector 1.

The partition wall 31 becomes gastight by being attached with the connector 1. An air or a gas is discharged or injected through an exhaust-intake opening 312 and thus the partition wall 31 is in a state in which the pressure inside the partition wall 31 is decreased or increased against the outside. The electronic component and the constitutional device of the internal circuit board 32 operate under such pressure.

The connector 1 according to the present embodiment has the high gastightness as described above and maintains the gastightness of the inside of the partition wall 31 over a long term.

Next, a second embodiment according to the present invention will be described. In the following description of the second embodiment, elements same as those in the embodiment described above are respectively provided with the same signs and differences from the above-described embodiment will be described.

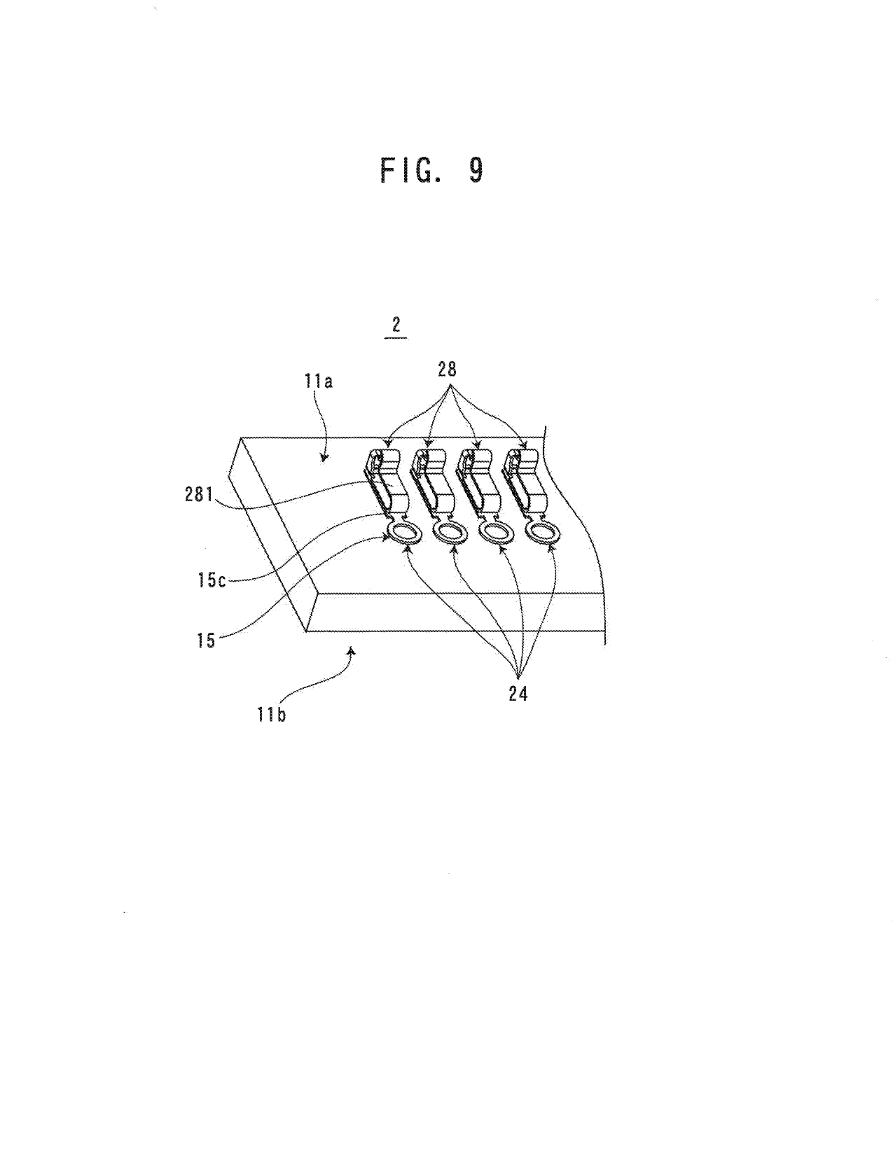

A connector 2 illustrated in FIG. 9 is different from the connector 1 according to the first embodiment in that the connector 2 includes contact members 28 which are provided on the electrical connection sections 24. The connector 2 is similar to the connector 1 in other aspects. FIG. 9 illustrates a portion corresponding to four electrical connection sections 24 of the connector 2.

The contact members 28 of the connector 2 are arranged on both the top face 11 a and the bottom face 11b of the insulation board 11. The contact members 28 are connected by soldering to the contact sections 15c of the connecting conductor patterns 15. The contact members 28 are members formed by stamping and forming a conductive metal plate and include elastic connection sections 281 which elastically make contact with another circuit board.

The connector 2 according to the present embodiment is used when the internal circuit board 32 and the external circuit board 33 of the apparatus 3 illustrated in FIG. 8 do not include the contacts 321 and 331. The connector 2 is directly connected to conductor patterns (not illustrated) of the internal circuit board 32 and the external circuit board 33 of the apparatus 3 illustrated in FIG. 8.

In FIG. 9, the contact members 28 of the connector 2 are arranged on both the top face 11a and the bottom face 11bof the insulation board 11. However, the present invention is not limited to this. For example, the contact members may be arranged on one face side of an insulation board.

In addition, the insulation board 11 in the embodiments described above has an oval shape. However, the present invention is not limited to this. The shape of the insulation board may be, for example, rectangular.

In addition, the strip-shaped sealing metal plating pattern 12 in the embodiments described above is arranged on the periphery of the top face 11a of the insulation board 11. However, the strip-shaped sealing metal pattern may continuously spread to a side face of the insulation board. In addition, the strip-shaped sealing metal plating pattern may be arranged on the bottom face of the insulation board and the connector may be arranged with the bottom face facing the partition wall.

In addition, in the embodiments describe above, the cylindrical column made of metal is described as an example of the rod-shaped member according to the present invention. However, the present invention is not limited to this. The rod-shaped member may be a resin material whose surface is plated, or may be a prism.

Further, each of the solder 17 in the embodiments described above surrounds the entire periphery of the rod-shaped members 16. However, the present invention is not limited to this. A portion of each of the rod-shaped members may make contact with each of the conductive patters of the through holes.

Furthermore, 28 positions of the electrical contact sections 14 are provided in the embodiments described above. However, the present invention is not limited to this. The number of the electrical contact sections may be other than 28. In addition, regarding the shape of the electrical contact sections, the electrical contact sections may include, for example, further extended portions on the top face and the bottom face.

Advantageously, as described above, according to the present invention, a connector having an enhanced gastightness is obtained.

What is claimed is:

1. A connector comprising:
an insulation board having a top surface, a bottom surface, and a through hole extending from the top surface to the bottom surface;
a conductor pattern covering an internal wall of the through hole;
a rod-shaped member extending in the through hole in a direction intersecting the top surface, with a first end protruding from the bottom surface and a second end opposite to the first end within the through hole; and
solder in a gap between the conductor pattern and the rod-shaped member and covering the second end of the rod-shaped member.

2. The connector according to claim 1, wherein the rod-shaped member is made of a metal material.

3. The connector according to claim 1, wherein the solder surrounds the entire periphery of the rod-shaped member.

4. The connector according to claim 1, wherein the rod-shaped member extends axially of the through hole.

5. The connector according to claim 1, wherein the rod-shaped member extends along the axis of the through hole.

6. The connector according to claim 1, wherein the conductor pattern has a first edge section that extends outward of a first end of the through hole and in the form of an annular ring on the top surface of the insulation board, and a second edge section that extends outward of a second end of the through hole and in the form of an annular ring on the bottom surface of the insulation board.

7. The connector according to claim 6, wherein the rod-shaped member extends along the axis of the through hole.

8. The connector according to claim 7, wherein the rod-shaped member is cylindrical.

9. The connector according to claim 8, wherein the rod-shaped member is made of a metal material.

10. The connector according to claim 8, wherein the solder surrounds the entire periphery of the rod-shaped member.
